(19) United States
(12) Patent Application Publication
(10) Pub. No.: US 2004/0245162 A1
(43) Pub. Date: Dec. 9, 2004

(54) Installation/removal tool for basket strainers

(76) Inventor: Daniel A. Horn, Burleson, TX (US)

Correspondence Address: Daniel A. Horn, 2532 Timber Road, Burleson, TX, 76028, US

(21) Appl. No.: 10/789,130

(22) Filed: Feb. 27, 2004

Related U.S. Application Data
(60) Provisional application No. 60/450,973, filed on Feb. 28, 2003.

(51) Int. Cl. C02F 1/00

(52) U.S. Cl. 210/232

(57) ABSTRACT

A basket strainer installation/removal tool has an internally threaded cylindrical passageway extending therethrough. A threaded shaft extends through the internally threaded passageway and has a conical cam at the lower end thereof. The conical cam forces radially extending cylindrical cams outwardly against the action of an elastomeric band encircling the lower end of the body to secure the tool into engagement with a basket strainer.

### TECHNICAL FIELD

This invention relates generally to hand tools, and more particularly to a hand tool specifically designed for the installation and removal of basket strainers.

### BACKGROUND AND SUMMARY OF THE INVENTION

Basket strainers are utilized in conjunction with kitchen sinks, laundry sinks, utility sinks, and similar applications. The basket strainer is situated at the bottom of the sink and serves as a conduit for directing water out of the sink and into a drain pipe situated below and connected to the basket strainer.

A basket strainer differs from other sink discharge devices in that it includes an upper relatively large diameter portion which may receive a basket for receiving and draining waste materials. The upper large diameter portion of the basket strainer is externally threaded and receives a threaded fastener which secures the basket strainer to the bottom of the sink. The basket strainer further includes a lower relatively small diameter portion extending downwardly from the large diameter portion which may receive a stopper to retain water in the sink. The exterior of the lower relatively small diameter portion is externally threaded for connection to a drain pipe utilizing conventional fasteners. As is well known to those skilled in the art, the basket and the stopper for a basket strainer may be parts of a combined basket/stopper device.

Although commonly used, basket strainers have heretofore been difficult to install particularly in circumstances in which the sink which is to receive the basket strainer is already installed. The present invention overcomes this difficulty by providing a hand tool which is specifically adapted to the installation and removal of basket strainers.

In accordance with the present invention a basket strainer installation/removal tool includes a body comprising a right circular cylinder. A threaded hole extends axially through the body and receives a shaft having a conical cam positioned at the lower thereof. A plurality of cylindrical cams are slidably supported in radially extending passageways located at the bottom of the body and are retained by an elastomeric band encircling the lower end of the body. The cylindrical cams are moved inwardly and outwardly relative to the body under the action of the conical cam as the threaded shaft moves downwardly and upwardly in response to rotation thereof relative to the body.

Outward movement of the cylindrical cams under the action of the conical cam forces the elastomeric band encircling the body of the basket strainer installation/removal tool against the interior surface of the upper large diameter portion of the basket strainer thereby securing the basket strainer in engagement with the tool. The tool is thereafter utilized to retain and secure the basket strainer during installation of the basket strainer in the sink or removal of the basket strainer from the sink.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of a basket strainer installation/removal tool incorporating the present invention;

FIG. 2 is a perspective view of a basket strainer;

FIG. 3 is a sectional view of the basket strainer installation/removal tool of FIG. 1; and

FIG. 4 is a sectional view of the basket strainer of FIG. 2.

### DETAILED DESCRIPTION

Referring now to the Drawings, and particularly to FIG. 2, there is shown a conventional basket strainer 10 of the type commonly used in kitchen sinks, utility sinks, laundry sinks, and the like. The basket strainer 10 has an outer rim 12 extending to an upper cavity 14 characterized by a relatively large diameter D1. The upper cavity 14 extends to a lower cavity 16 characterized by a relatively small diameter D2. Both the upper cavity 14 and the lower cavity 16 are externally threaded as indicated at 18 and at 20, respectively.

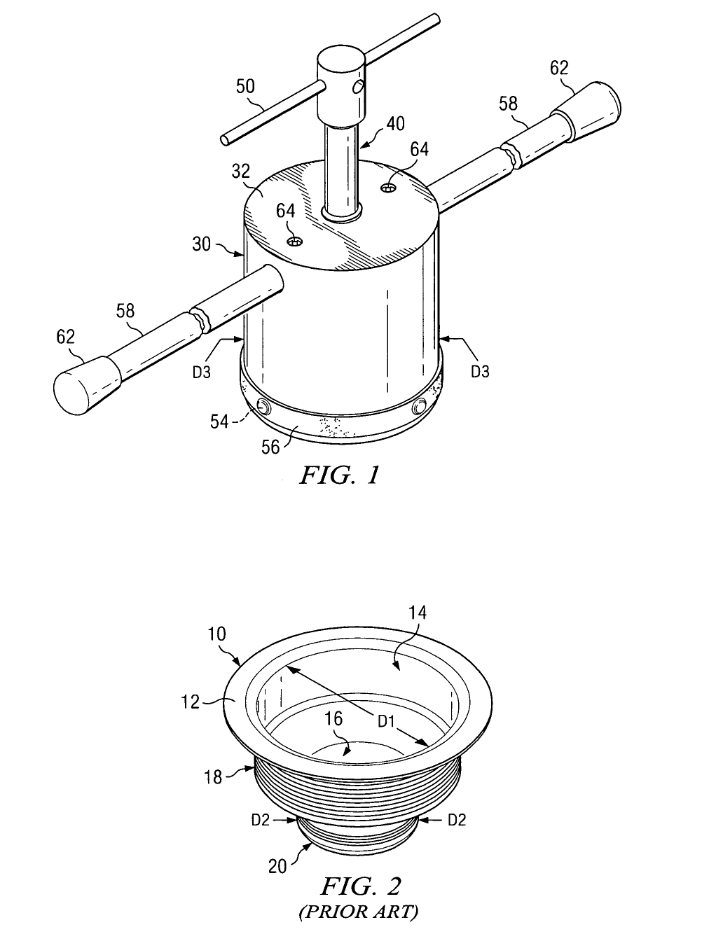

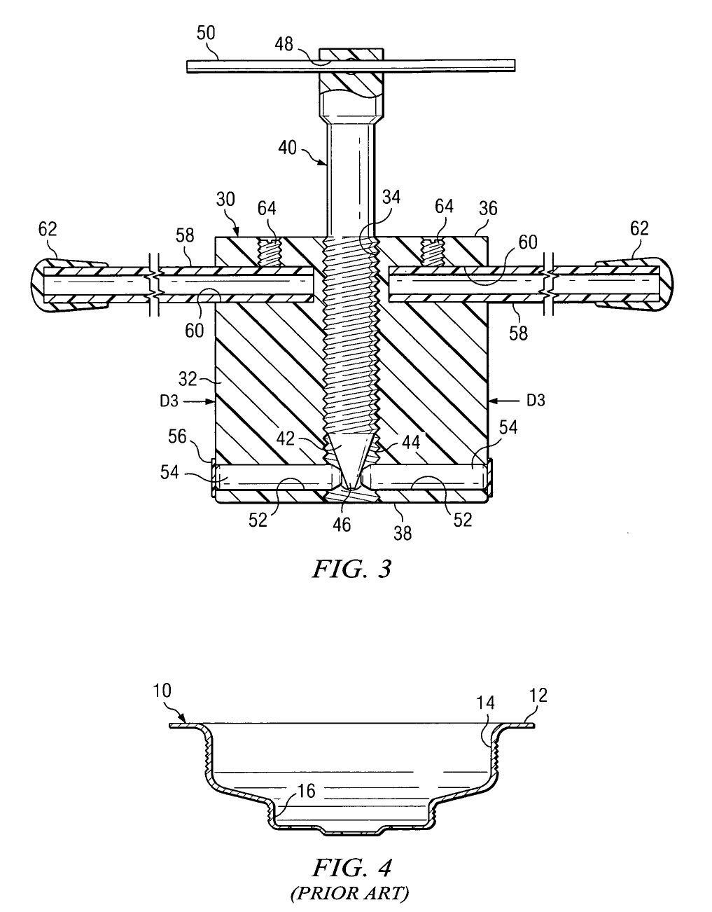

A basket strainer installation/removal tool 30 incorporating the present invention is illustrated in FIGS. 1 and 3. The tool 30 comprises a body 32 characterized by an external diameter D3 which is closely matched to but slightly smaller than the internal diameter D1 of the upper cavity 14 of the basket strainer 10. The body 32 of the tool 30 comprises a right circular cylinder.

Referring particularly to FIG. 3, the body 32 is provided with a threaded hole 34 which extends from the top 36 to the bottom 38 of the body 32 along the axis thereof. A threaded shaft 40 is threadedly engaged with the threaded hole 34 such that rotational movement of the shaft 40 causes the shaft 40 to move inwardly and outwardly relative to the body 32. The lower end 42 of the threaded shaft 40 is provided with a conical cam surface 44 which in turn extends to a distal end 46. The upper end of the threaded shaft 40 is provided with a transverse aperture 48 which receives a handle 50.

The lower end of the body 32 is provided with a plurality of radially extending cam receiving passageways 52. A cylindrical cam 54 is received in each passageway 52. The cylindrical cams 54 are retained in the passageways 52 by an elastomeric band 56 which extends around the outer periphery of the body 32 in alignment with the cams 54.

As will therefore be understood, when the handle 50 is actuated to rotate the threaded shaft 40 in a direction which causes the threaded shaft 40 to move inwardly relative to the body 32, the conical cam 44 engages the inboard ends of the cylindrical cams 54, thereby forcing the cams 54 outwardly against the action of the elastomeric band 56. Conversely, when the handle 50 is rotated in a direction to cause the threaded shaft 40 to move outwardly relative to the body 32 the cam 44 is disengaged from the cylindrical cams 54 thereby causing the cams 54 to move inwardly in the passageways 52 under the action of the elastomeric band 56.

The tool 30 further includes a pair of handles 58 which are received in apertures 60 extending radially into the body 30. The distal ends of the handles 30 may be provided with elastomeric covers 62. The handles 58 are retained by set screws 64 which are threadedly engaged with the body 30.

In the use of the tool 30, the handles 58 are utilized to engage the lower end 38 of the body 30 with the large diameter cavity 14 of a basket strainer 10. Preferably, the body 32 of the tool 30 is advanced into the large diameter cavity 14 until it engages the bottom thereof. Thereafter the handle 50 of the threaded shaft 40 is actuated to rotate the threaded shaft 40 in a direction which causes the threaded shaft 40 to move inwardly relative to the body 32 of the tool 30. Inward movement of the threaded shaft 40 causes the cam 44 to engage the inboard ends of the cylindrical cams 54 to move the cams 54 outwardly against the action of the elastomeric band 56. Rotation of the threaded shaft 40 continues until the cams 54 have been moved outwardly far enough to securely engage the tool 30 with the basket strainer 10.

After the tool 30 has been securely engaged with the basket strainer 10 the handles 58 of the tool 30 are engaged to effect rotation of the basket strainer 10, it being understood that the direction of rotation depends on whether the basket strainer 10 is being installed or removed. Rotation of the basket strainer 10 under the action of the tool 30 continues until the threads 18 and/or the threads 20 of the basket strainer 10 are fully engaged with or fully disengaged from the mating threads comprising the surrounding structure. Alternatively, the handles 58 may be used to prevent rotation of the basket strainer 10 during engagement or disengagement of a threaded fastener therewith.

Following installation or removal of the basket strainer 10 the handle 50 of the threaded shaft 40 is rotated to retract the threaded shaft 40 relative to the body 32. This action disengages the cam 44 from the cams 54 whereupon the cams 54 are moved inwardly relative to the body 32 under the action of the elastomeric band 56. When the cams 54 have been moved inwardly sufficiently to disengage the tool 30 from the basket strainer 10 the handles 58 are utilized to remove the tool 30 from the basket strainer 10.

Preferably the tool 30 of the present invention is formed entirely from plastic with the possible exception of the set screws 64. The body 32 may comprise a non-threaded hole in which an internally threaded tube is securely retained.

The cylindrical cams 54 of the basket strainer installation/removal tool 30 can also be actuated by mounting a plurality of camming lobes on a non-threaded shaft extending through a non-threaded cylindrical passageway formed in the body 32. Each of the camming lobes is aligned with one of the cylindrical cams 54 and functions to force its respective cylindrical cam 54 outwardly upon rotation of the non-threaded shaft relative to the body 32. Preferably, the non-threaded shaft is provided with a ratchet wheel and the body 32 is provided with a ratchet detent for securing the cylindrical cams 54 in engagement with a basket strainer.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A basket strainer installation/removal tool comprising:
a body having an axis and having an upper end and a lower end;
a cylindrical passageway extending through the body from the upper end to the lower end along the axis thereof;
a plurality of radially extending passageways formed in the lower portion of the body and each extending continuously from the axially extending cylindrical passageway to the exterior of the body;
a shaft mounted in the cylindrical passageway of the body for rotation therein;
a plurality of cylindrical cams mounted in the cylindrical passageways for inward and outward movement relative to the body;
camming means mounted on the shaft for moving the cylindrical cams outwardly responsive to rotation of the shaft relative to the body;
said cylindrical cams for effecting gripping engagement between the basket strainer installation/removal tool and a basket strainer.

2. A basket strainer installation/removal tool comprising:
a body having an axis and having an upper end and a lower end;
a cylindrical passageway extending through the body from the upper end to the lower end along the axis thereof;
a plurality of radially extending passageways formed in the lower portion of the body and each extending continuously from the axially extending cylindrical passageway to the exterior of the body;
a shaft mounted in the cylindrical passageway of the body for rotation therein;
a plurality of cylindrical cams mounted in the cylindrical passageways for inward and outward movement relative to the body;
an elastomeric band encircling the lower end of the body in alignment with the cylindrical cams for resisting outward movement of the cylindrical cams;
the elastomeric bands for engagement with the interior surface of a basket strainer whereby the basket strainer is secured in engagement with the cylindrical body of the tool by outward movement of the cylindrical cams; and
camming means mounted on the shaft for moving the cylindrical cams outwardly responsive to rotation of the shaft relative to the body.

3. A basket strainer installation/removal tool comprising:
a body comprising a right circular cylinder defined by an axis and having an upper end and a lower end;
a cylindrical passageway extending through the body from the upper end to the lower end along the axis thereof;
at least a portion of the cylindrical passageway extending through the body being internally threaded;
a plurality of radially extending passageways formed in the lower portion of the body and each extending continuously from the axially extending cylindrical passageway to the exterior of the body;
a threaded shaft mounted in the cylindrical passageway of the body in threaded engagement with the internal threads thereof for upward and downward movement relative to the body in response to relative rotation with respect thereto;
a conical cam mounted at the lower end of the threaded shaft;
a plurality of cylindrical cams mounted in the cylindrical passageways for inward and outward movement relative to the body responsive to movement of the conical cam under the action of the threaded shaft;
an elastomeric band encircling the lower end of the body in alignment with the cylindrical cams for resisting outward movement of the cylindrical cams under the action of the conical cam and for moving the cylindrical cams inwardly within the cylindrical passageways when the conical cam is moved upwardly relative to the body under the action of the threaded shaft; and
the elastomeric bands for engagement with the interior surface of a basket strainer whereby the basket strainer is secured in engagement with the cylindrical body of the tool by outward movement of the cylindrical cams responsive to downwardly movement of the conical cam responsive to rotation of the threaded shaft relative to the body.
